(19) United States
(12) Patent Application Publication
(10) Pub. No.: US 2004/0242325 A1
(43) Pub. Date: Dec. 2, 2004

(54) Game system for handheld personal devices

(76) Inventors: Valery Levitan, Thornhill (CA); Boris Itskov, Thornhill (CA)

Correspondence Address: DENNISON ASSOCIATES, 133 RICHMOND STREET WEST, SUITE 301, TORONTO, ON, M5H 2L7, CA

(21) Appl. No.: 10/809,329

(22) Filed: Mar. 26, 2004

(30) Foreign Application Priority Data
Mar. 28, 2003 (CA) 2,423,989

(51) Int. Cl. A63F 13/00

(52) U.S. Cl. 463/41

(57) ABSTRACT

A game server system including a game server which is accessed by handheld personal portable devices such as PDA's or cell phones. These personal portable devices have a primary business, data storage, communication or other practical function in combination with a secondary personal entertainment function. The devices have the ability to communicate over a communication network with a game sever computer and download games and/or receive and transmit game information. Certain games of the handheld personal portable devices include as part thereof a tracking arrangement for tracking game use information for later communication to the game server computer. With this arrangement two way synchronization occurs between each handheld personal portable device and the game server computer.

### FIELD OF THE INVENTION

The present application relates to game systems and in particular, to game systems operable using personal portable devices having a primary function other than game entertainment. The invention is also directed to game applications capable of communicating with a game server.

### BACKGROUND OF THE INVENTION

Personal portable devices such as personal data assistances (PDA's) and cell phones continue to increase in popularity and use. Electronic communication using portable devices allows users to stay in communication and/or modify or access personal records. These functions are often critical elements for business and other professionals. Although these portable devices have a primary communication, business or other useful function, the devices also provide a secondary personal entertainment function involving games which can be played using these devices. Many personal portable devices are preprogrammed with certain games, however, it is also known to download games to the device.

Although this secondary game function is a desirable benefit, the game entertainment value decreases over time.

For more sophisticated game players, it is known to connect with a game server over a communication network to allow certain games to be purchased and/or downloaded. These game servers also allow a user to communicate his game results to the server for collection, evaluation and posting on the game server. This approach allows a user to share his game results with others and to download different games from time to time. Most of these systems require the user to become a registered user of the game server and to pay for the various games to be downloaded. Most of the games are customized to be memory efficient and to operate on a particular device.

The known game server systems are attractive to a certain small segment of game users who are technically astute, active and competitive. Although this is an active well defined market segment, it is of limited size and represents only a small percentage of the existing PDA and cell phone users.

The present invention provides a system which is more attractive to the PDA and cell phone user population and allows effective advertisement or promotion to this market in a cost effective and frequent manner.

### SUMMARY OF THE INVENTION

A personal portable device is used in combination with a game server computer. The personal portable device is carried by a user and has a primary practical function and a secondary personal entertainment function. The primary practical function includes the capability to communicate over a communication network with a separate computer. The secondary personal entertainment function includes a series of downloaded games downloaded to the personal portable device using the communication capability of the primary practical function to connect with the game server computer. The game server computer downloads at least one additional game. The at least one additional game includes as part thereof includes a tracking arrangement for tracking use information with respect to the play of the at least one game and to communicate the use information to said game server computer when said personal portable device is in communication with the game server computer.

In a further aspect of the invention, the web browser function of the personal portable device when used to connect with the game server computer allows a user to initially register with the game server computer as a registered user or if the user has previously registered to communicate use information to the game server computer and additionally receive from the game server computer collective summary use information reflective of use information from all the registered users.

In a preferred aspect of the invention the at least one additional game is operable or selectively operable in a sweepstake mode.

In yet a further aspect of the invention, the collective summary use information is stored in the personal portable device and selectively displayed when the personal portable device is in said personal secondary entertainment function.

In an aspect of the invention, the at least one game includes a display function for displaying game use information received from the game server computer.

In a further aspect of the invention, the game server computer downloads a series of games to the personal portable device.

In a preferred aspect of the invention, at least some of the series of games are eligible for operating in a sweepstake mode based on registration and the number of times the eligible games are played and communicated to the game server computer.

In yet a further aspect of the invention, each game operating in a sweepstake mode includes advertisement of a sponsor displayed on the personal portable device during use of the game.

In an aspect of the invention the personal portable device is a personal data assistant device which communicates with the game server computer when the personal data assistant device is linked with a computer which connects with the game server computer and allows communication of the personal data assistant with the game server computer.

In a further aspect of the invention, the game server computer downloads a plurality of games to the personal portable device and provides the user with several options for playing at least some of the games in a sweepstake mode.

### BRIEF DESCRIPTION OF THE DRAWINGS

Preferred embodiments of the invention are shown in the drawings, wherein:

FIG. 1 is a schematic showing a PDA device or cell phone device in communication with the game server

FIG. 2 shows a main menu page which is displayed when the games server is contacted;

FIG. 3 is a login screen;

FIG. 4 is a screen displaying the Hall of Fame information when activated;

FIG. 5 is a screen showing the overall results of a particular game based on all users; and

FIG. 6 is a screen which is displayed when the device is being synchronized with the game server.

### DETAILED DESCRIPTION OF THE PREFERRED EMBODIMENTS

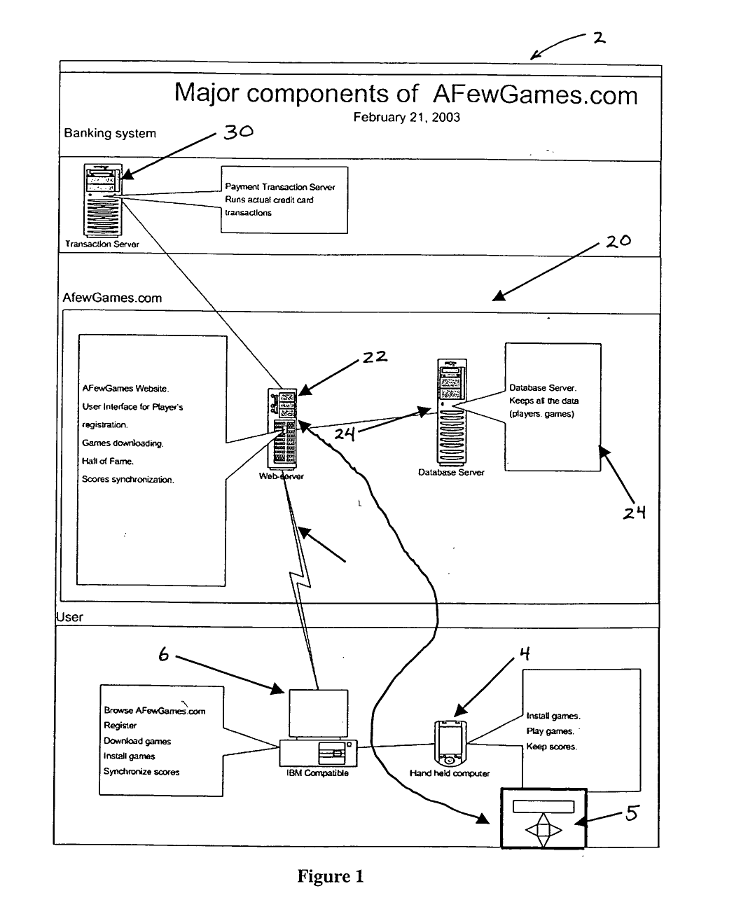

FIG. 1 shows an overview of the system for use in association with a personal data assistant (PDA). The game communication system 2 allows a personal portable device 4 to communicate with a game server computer 20. The game server computer 20 includes a web server 22 having associated therewith a database server 24. As will be more fully explained, the game server computer 20 allows a personal portable device to connect to the game server computer, register with the game server computer, and allow downloading of games. The game server computer also downloads game information of others to the personal portable device and the uploading of information from the personal portable device to the game server computer for compilation as part of the overall users' statistics. The game server computer 20 also includes a financial transaction server 30 to allow a user to pay for various services using standard payment options.

In the case of the PDA device 4, the primary function of the device is the recording of data and information of the user. The device also includes a secondary entertainment function including a number of games which can be played on the device. The PDA device has a cradle which receives the PDA device and allows synchronization of the PDA device with a user's computer generally shown as 6. The user's computer 6 is connected via a suitable communication connection 8 to the game server computer 20. This communication arrangement allows game information to be uploaded from the PDA 4 to the game server computer 20 and to allow downloading of games and overall game information from the game server computer 20 to the PDA 4.

FIG. 1 also shows a cell phone 5 in communication with the game server computer 20. The description refers to one game server computer, however several game server computers could be used.

Continued advancement of communication and data manipulation and storage technologies has produced a tendency to converge a number of personal portable devices 4 into a single device which satisfies all functions. In particular, cell phones are a personal portable device that provide convenient telephone capabilities. Cell phones also have a secondary function which includes the capability of playing games. More recently cell phones have been provided with a small screen and controls for web surfing. Similarly, PDA devices have recognized the need to communicate and have been provided with e-mail and text messaging capabilities as well as cell phone capability. It is anticipated that the personal portable device whose primary function may include data storage and/or personal communication capability will continue to merge to effectively satisfy the various needs of the user. This merging of the technologies is evident from the recent combined cellular telephone digital camera which allows communication of digital images over the cellular network in addition to the voice communication capability.

As the sophistication of the technology and users continues to grow, the entertainment component or capability of the device can also expand using the present game system. The users of PDA's and cell phones which have a capability of communicating with a game server, defines a market population where part of this population is willing to pay for additional entertainment services. This market segment includes the target market of many companies and the secondary entertainment capability of these devices is improved by providing more sophisticated game services in a cost affective manner.

PDA's continue to advance and can communicate in different ways and not necessarily through an associated personal computer. For example, some PDA's can communicate using network cards or through wireless communication.

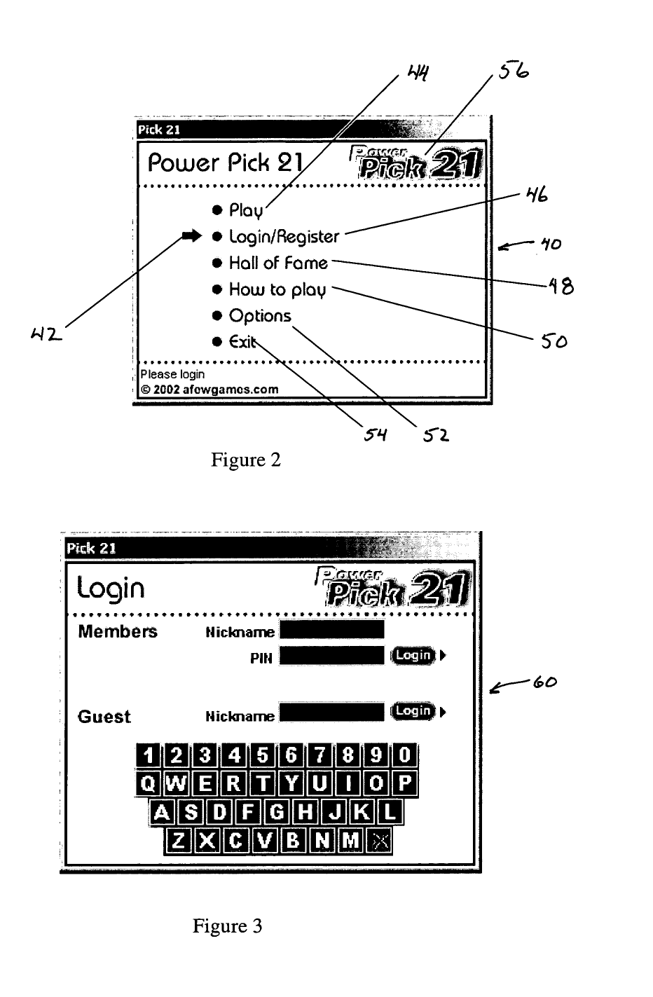

FIGS. 2 through 6 show various menus which the personal portable device displays to allow a user to operate the game system and communicate with the game server computer.

FIG. 2 illustrates the main game menu page which is displayed on the personal portable device when a short cut to the game has been activated by the user. The screen 40 includes a movable cursor 42 and a series of options 44, 46, 48, 50, 52 and 54 which can be executed by the user. The screen 40 also includes an advertising banner 56 near the top of the screen. The first option 44 allows the user to play the particular game Power Pick 21. Execution of the second option 46 will allow a user to login or register with the game server computer 20. The Hall of Fame option 48 provides game performance reports by user either locally based on games played on the device or globally based on all users of the games. Instruction option 50 provides an explanation how the game is played. Option 52 informs the user of other available capabilities. Exit option 54 allows a user to terminate the procedure.

FIG. 3 provides a login screen where members can login or a guest can login. This login capability allows the personal portable device to record game use information and/or game performance information and store this information in a database. The database is initially limited to the personal portable device to provide a record of this information for games played on the particular device, however, it also allows communication of this local information to the game server computer 20 when the device is connected to the game server computer for entry in the global database. The results of the global database are downloaded to each personal portable device as subsequently explained. The login screen 60 distinguishes between a user who is a guest and a user who is a member. The login for a guest keeps the information in the database for local results. The login as a member requires previous registration with the game server and these game results will be stored in the database and eventually communicated to the game server.

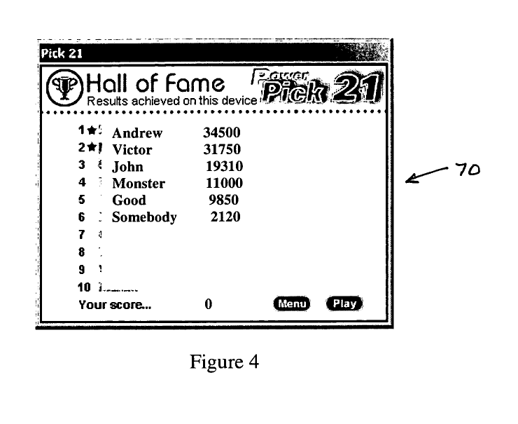

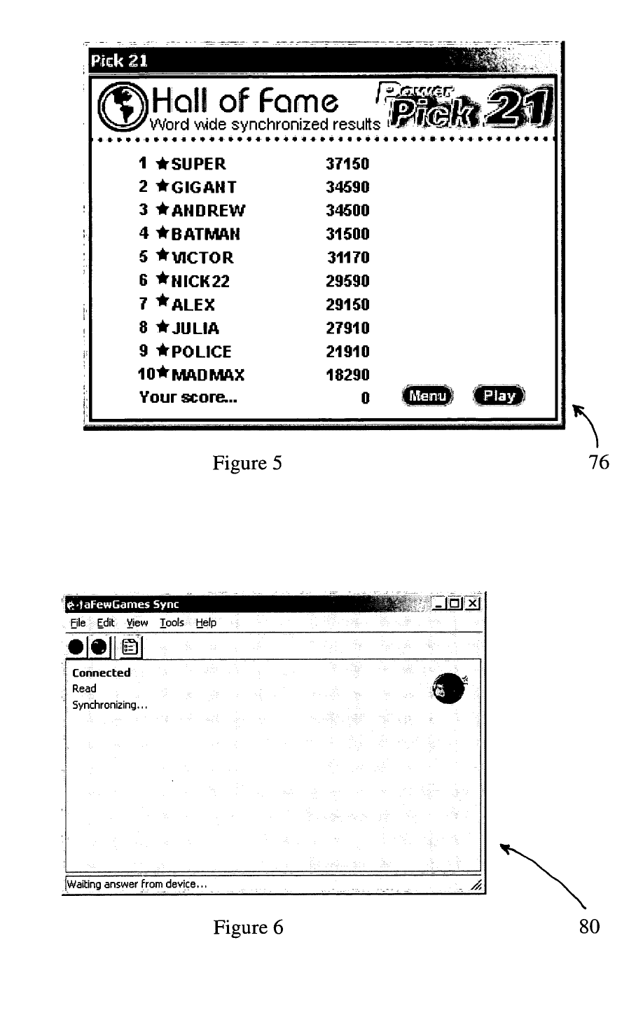

The Hall of Fame screen 70 of FIG. 4 is activated by the user executing item 48 on screen 40 of FIG. 2. Screen 70 provides local results of both members and guests who have logged in on the device and played the particular game Power Pick 21. A ranking of the various members and guests is provided. By tapping the cup symbol 72 the user can access the global standings shown on the Hall of Fame screen 76 of FIG. 5. Thus, the player can compare the personal best on this particular device by a member or guest and can also review the global results which have been downloaded to the PDA when the PDA was connected to the game server. These global results are typically confined to members.

With the present system, the local results are maintained by the personal portable device 4 and communicated to the game server when the personal portable device is connected to the game server computer 20. Once in communication with the game server computer, synchronization of the game server and the personal portable device occurs. The synchronization screen 80 is shown in FIG. 6. Synchronization is performed by means of a utility of the game server computer 20. This synchronization feature is enabled on the user's desktop after successful installation of any of the games. When installed and activated, the synchronization icon is visible in the windows system tray. By default, the sync utility starts the synchronization process each time the PDA is inserted in the cradle. As can be appreciated, other arrangements can be specified or selected from a series of options. For example, the user may select an option where the game is only synchronized at the request of the user and when the PDA device is in a cradle.

With the present system, the personal portable device 4 uses its own or an associated communication capability for effecting communication with the game server computer 20. Once connected to the game server computer 20, various games can be downloaded to the personal portable device 4 for play on the portable device. In addition, a database is established which allows the game play and game scores or other information including the particular users to be maintained in the database until such time as the personal portable device again connects with the game server computer. The game server computer 20 also downloads global game performance information to the personal portable device when it is connected to the game server computer. The financial transaction server 30 allows the user to authorize payment for any games downloaded or subscription services that may be associated with the game server computer.

It is anticipated that the game server computer will also include a number of games which are operable in a sweepstake mode. The sweepstake mode will be based on the number of times a particular game is played during a certain time period. There may also be a certain maximum cap that any particular user or user device cannot exceed. For example, although the user can continue to play the game, once the cap for the maximum number of games for that particular user has been reached, the user can continue to play the game but this additional play will not provide an additional entry in the sweepstake mode. Therefore, with sweepstake mode games a maximum cap may be used. In other circumstances, there may be no cap or a cap which can be extended in a predetermined manner.

It is fully anticipated that a number of these games will include corporate sponsorship. The corporate sponsorship may include a game which is customized for the particular sponsor and will include advertising in the advertising banner each time the game is played. The corporate sponsored games may be fully funded by the corporate sponsor or may be partially sponsored. Certain games may include several corporate sponsors. These corporate sponsored games can be downloaded to various personal portable devices either free of charge or for a small fee if they wish to operate in sweepstake mode. As can be appreciated, many different payment arrangements can be used.

With this game server computer arrangement the typical users of the personal portable device are encouraged to play games either for the entertainment value and/or for the ability to enter a particular sweepstake or tournament. Thus this gaming system is attractive to a much larger market segment and provides the corporate sponsor with an opportunity to directly market or advertise to this known market segment.

It is anticipated that the games in sweepstake mode will change from time to time to encourage additional users and to maintain a high level of interest. With the system, the users are comparing their own game skills with other users of their personal portable device as well as the ability to compare on a global basis.

According to a preferred feature of the invention, the step of synchronizing the personal portable device with the game server computer, communicates to the game server computer what games have previously been downloaded to the device. This allows the game server computer to update the sweepstake mode status of games stored on the device and to enable a visual indication when these games are listed on the device that the games are eligible for sweepstake mode.

The game server computer preferably offers a number of games which coordinate with the game server using the same screens. In this way, less-memory is required for multiple games. Also synchronization can occur for all games and updates can be done during synchronization.

The present system has been described with respect to a separate game server computer where the user decides to contact this server. It is also possible that the device is a cell phone or other communication device which is in contact with a computer system for performing a communication function. As part of this communication function, the device can be updated to include games which are in sweepstake mode and previously stored on the device. It can also include the capability of providing a text message or short advertising indicating which games can be downloaded for use in sweepstake mode. This is particularly attractive to communication providers such as separate cell phone providers who wish to provide an additional service or perk to their dedicated customers to encourage brand loyalty. It also provides the opportunity for the communication provider to enter into cooperative advertising on a promotion with other corporate entities through their subscriber base. With this arrangement, it is possible to combine a number of sponsors where eligibility in a particular sweepstake can be based on a number of separate and distinct eligibility steps. For example, a person could be eligible by playing a particular game which has been indicated as operable in sweepstake mode. This contest could also include eligibility in the sweepstake by payment of a particular financial transaction with a credit card. These results can be combined with the game server computer and the common promotion of the sweepstake can appeal to a number of separate and distinct markets. Obviously, with more participants, the particular prize or prizes can be of increased value and appeal.

The present system also allows marketing information to be provided either directly or indirectly by the subscriber. Certain games may be eligible merely by the customer answering a short marketing survey on the device.

The present system allows various users to purchase games and download the games for play on the device. A user may subscribe to the game server computer and receive various capabilities based on the level of subscription service. For example, many games on the game server computer can be downloaded to a user device free of charge for play on the particular device. Such games may include a particular expiry period where the ability to play the game will expire. This allows the user to first experience the game and decide whether it is desirable to have the game available on the device on a permanent basis. If the user decides that it is a desirable game, he can then contact the game server and pay for the game for permanent use. It is also anticipated that the user may decide to subscribe to the service as a premier member. The various levels of membership will provide different functions.

For example, basic subscription service may allow downloading and playing of demo versions of games, global score ranking and online purchasing of packaged games. A premier membership in addition to the basic functions may support tournament play, league play, eligibility for sweepstake promotions and contests, and facilitate the forming and administration of their own league or tournament.

The game system allows corporate sponsorship and the collection and distribution of marketing demographics.

It is anticipated registered members will be pay a subscription fee to synchronize their local game results with results obtained on a global basis.

The game server computer will preferably operate a number of tournaments for fame or recognition. In certain jurisdictions, it may be possible to run tournaments for prizes, however, these are not legal in all jurisdictions. The game server computer where possible, will screen the various personal portable devices when they initiate communication with the game server computer to confirm jurisdiction requirements are met. With this arrangement PDA's, cell phones and other handheld personal devices can include games operated in a tournament mode and communicate with a game server computer to transfer information thereto and receive tournament information including tournament ranking information.

It is also anticipated that registered members will be capable of organizing a league or joining a league. The ability to carry out this feature will be dependent upon a subscription or membership qualification. The actual game server computer can provide and promote open leagues whereas individual members can operate closed leagues or determine particular requirements for entry in the league.

Another application of this technology is associated with satellite, cable or telephone related television broadcast technology having a download capability and computer processing capability. Television satellite boxes associated with subscription or pay per view television can be modified to accommodate this game technology. Games would be downloaded to the receiver which allows play on the television. Game tracking information associated with the sweepstake incentives and/or the tournament incentive approaches would be uploaded to the game server computer. The games could be provided free of charge or on a cost to play basis. Advertising associated with the downloaded games could justify the free games or reduce the cost of games. As can be appreciated, this capability could also be bundled with the cost of the television subscription service. League play or player to player challenge play would be particularly effective. This approach brings the video arcade technology to be home while allowing involvement with a large number of similar users. Other approaches for providing of the games are possible in combination with the ability to upload game tracking or game results information. This ability to upload also allows players to sign on or track their results independent of the subscribed service. This capability can be combined with the PDA and cell phone applications.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A personal portable device to be carried by a user and having a primary practical function and a secondary personal entertainment function, said primary practical function including the capability to communicate over a communication network with a separate computer, said secondary personal entertainment function includes a series of downloaded games downloaded to said personal portable device using said communication capability of said primary practical function to connect with a game server computer and have said game server computer download at least one additional game, said at least one additional game including as part thereof a tracking arrangement for tracking use information with respect to the play of said at least one game and to communicate said use information to said game server computer when said personal portable device is in communication with said game server computer.

2. A personal portable device as claimed in claim 1 wherein at least one same is operable in a sweepstake mode offered through said game sever computer.

3. A personal portable device as claimed in claim 1 wherein said personal portable device is a cell phone with a web browser function, and said web browser function is used to access and communicate with said game server computer.

4. A personal portable device as claimed in claim 1 wherein said web browser function when used to connect with said game server computer allows a user to initially register with said game server computer as a registered user or if the user has previously registered to communicate use information to said game server computer and additionally receive from said game server computer collective summary use information reflective of use information from all the registered users.

5. A personal portable device as claimed in claim 4 wherein said collective summary use information is stored in said personal portable device and selectively displayable when said personal portable device is in said personal secondary entertainment function.

6. A personal portable device as claimed in claim 5 wherein said at least one game includes a display function for displaying game use information received from said game server computer.

7. A personal portable device as claimed in claim 5 wherein said game server computer downloads a series of games to said personal portable device.

8. A personal portable device as claimed in claim 7 wherein at least some of said series of games are eligible for operating in a sweepstake mode based on registration and the number of times the eligible games are played and communicated to the game server computer.

9. A personal portable device as claimed in claim 8 wherein each game operating in a sweepstake mode includes advertisement of a sponsor displayed on said personal portable device during use of said game.

10. A personal portable device as claimed in claim 9 wherein said advertisement is displayed on said portable display device during communication with said game server computer.

11. A personal portable device as claimed in claim 1 wherein said personal portable device is a personal data assistant device which communicates with said game server computer when said personal data assistant device is linked with a computer which connects with said game server computer and allows communication of said personal data assistant with said game server computer.

12. A personal portable device as claimed in claim 1 wherein said game server computer downloads a plurality of games to said personal portable device and provides the user with several options for playing at least some of said games in a sweepstake mode.
